(19) United States
(12) Patent Application Publication
(10) Pub. No.: US 2018/0283051 A1
(43) Pub. Date: Oct. 4, 2018

(54) WIRELESS CONTROLLED FINGERPRINT SMART LOCK

(71) Applicant: U-TEC GROUP INC, Fremont, CA (US)

(72) Inventors: Chenglin Qiu, Shanghai (CN); Lingling Qian, Shanghai (CN); Yongshuai Zhu, Shanghai (CN); Pengcheng Zhu, Shanghai (CN); Bin Ruan, Shanghai (CN)

(21) Appl. No.: 15/944,590

(22) Filed: Apr. 3, 2018

Related U.S. Application Data
(60) Provisional application No. 62/480,968, filed on Apr. 3, 2017.

(51) Int. Cl. E05B 51/00; H04W 12/08; G07C 9/00; G06K 19/07; E05B 1/00; E05B 19/00; E05B 17/22; E05B 47/00; E05B 39/00

(52) U.S. Cl. CPC E05B 51/00; H04W 12/08; G07C 9/00563; G07C 9/00182; G06K 19/0723; E05B 1/0053; E05B 2047/0067; E05B 17/22; E05B 47/0012; E05B 39/00; E05B 2047/0058; E05B 2047/002; E05B 19/00

(57) ABSTRACT

A smart lock comprises wireless enabled communication components and fingerprint enabled identification verification components. The fingerprint enabled identification verification components are configured to be at a location that a typical user's fingerprint is reachable and in a contact position when the user holds a handle of the lock. The smart lock is configured to be operable using Internet signals, bluetooth signals, and/or direct physical contact of a identification verification mechanism or method.

### CROSS-REFERENCE TO RELATED APPLICATION(S)

This application claims priority under 35 U.S.C. § 119(e) of the U.S. Provisional Patent Application Ser. No. 62/480,968, filed Apr. 3, 2017 and titled, “WIRELESS CONTROLLED FINGERPRINT SMART LOCK,” which is also hereby incorporated by reference in its entirety for all purposes.

### FIELD OF THE INVENTION

The present invention relates to the field of security. More specifically, the present invention relates to smart locks.

### BACKGROUND OF THE INVENTION

Typically locks lack smart features and require physical keys and forces to perform locking and unlocking, which cannot be controlled remotely.

### SUMMARY OF THE INVENTION

A smart lock comprises wireless enabled communication capability (e.g., bluetooth enabled) and fingerprint enabled identification verification devices and processes. In some embodiments, the identification verification device is structured and located at a rotational point of a door handle. In some embodiments, the smart lock is configured and structured to provide access request by using at least one of a fingerprint scanning verification device, access card that uses touchless sensing technology (e.g., using radio frequency), and remote control using smart phones. In some embodiments, a locking bolt, which is able to be a second locking device of the smart lock, is opened together, synchronized to be opened together, or delayed to be opened together when a first locking device is configured to be opened. In some embodiments, the smart lock contains batteries at both sides of the door, which ensures that the lock can be sufficiently powered to be in an operable state by the batteries on either side of the door. In some embodiments, a bridge connecter has one end that is signally coupled with a Wi-Fi system (e.g., a Wi-Fi router) and has another end that is paired with the smart lock, wherein the bridge connector is signally coupled with the smart lock, such as using bluetooth signals. With the bridge connector, a user is able to use a smart phone to control the smart lock and/or bolt any time from any location, such as 10 miles from the smart lock.

In an aspect, a smart lock comprising an electronic lock and a first identity verification component at a pivotal rotating point of a handle on the electronic lock. In some embodiments, the identity verification device comprises a fingerprint verification device. In other embodiments, the pivotal rotating point is positioned at a rotational axis of the handle. In some other embodiments, the first identity verification component comprises a fingerprint verification device. In some embodiments, the electronic lock comprises a second identity verification component operable using a wireless signal.

In some other embodiments, the second identity verification component comprises a keycard. In some embodiments, the keycard comprises radio-frequency circuits. In other embodiments, the radio-frequency circuits comprise radio-frequency identification (RFID) circuits. In some other embodiments, the second identity verification component comprises a control component configured to receive a control command from a smart phone. In some embodiments, the lock comprises two sets of batteries located at both sides of the lock, such that the lock is able to be powered from each side of the electronic lock.

In another aspect, a method of controlling a locking device comprises configuring the locking device to receive an identity verification information from a fingerprint verification device, a smart keycard, and a smart phone or a combination thereof, receiving the identify verification information from at least one of the fingerprint verification device, the smart keycard, or the smart phone, determining an access permission using a computing device, generating a granted access permission or a denied access permission based on the access permission determined, and causing the locking device to lock or open based on the generated granted access permission or the denied access permission. In some embodiments, the method further comprises configuring a bridge connector to receive a Wi-Fi signal and convert the Wi-Fi signal to a bluetooth signal. In other embodiments, the bridge connector communicates with the locking device using the bluetooth signal. In other embodiments, the method further comprises recording the granted access, the denied access, or both in a log stored in a computing device. In some embodiments, the log records a name and time of access. In some other embodiments, the method further comprises opening or locking a separate bolt together with a locking or opening status of the lock.

In another aspect, a smart lock system comprises a fingerprint verification device on a handle of a door lock device, one or more wireless identification verification devices on the door lock device, and at least one set of one or more batteries at each side of the door lock device, so that the door lock device is able to be powered from either side of the door lock device. In some other embodiments, the device further comprises a bridge connecter, which converts an Internet signal from a user's mobile device in a Wi-Fi signal to bluetooth signal for communicating with the door lock device.

Other features and advantages of the present invention will become apparent after reviewing the detailed description of the embodiments set forth below.

### BRIEF DESCRIPTION OF THE DRAWINGS

Embodiments will now be described by way of examples, with reference to the accompanying drawings which are meant to be exemplary and not limiting. For all figures mentioned herein, like numbered elements refer to like elements throughout.

FIG. 1 illustrates a smart lock in accordance with some embodiments.

FIG. 2 illustrates various constructions of identification verification devices on a smart lock system in accordance with some embodiments.

FIG. 3 illustrates an electronic locking system in accordance with some embodiments.

FIG. 4 illustrates a method of using the locking system in accordance with some embodiments.

### DETAILED DESCRIPTION OF THE PREFERRED EMBODIMENT

Reference is made in detail to the embodiments of the present invention, examples of which are illustrated in the accompanying drawings. While the invention is described in conjunction with the embodiments below, it is understood that they are not intended to limit the invention to these embodiments and examples. On the contrary, the invention is intended to cover alternatives, modifications and equivalents, which can be included within the spirit and scope of the invention as defined by the appended claims. Furthermore, in the following detailed description of the present invention, numerous specific details are set forth in order to more fully illustrate the present invention. However, it is apparent to one of ordinary skill in the prior art having the benefit of this disclosure that the present invention can be practiced without these specific details. In other instances, well-known methods and procedures, components and processes have not been described in detail so as not to unnecessarily obscure aspects of the present invention. It is, of course, appreciated that in the development of any such actual implementation, numerous implementation-specific decisions must be made in order to achieve the developer's specific goals, such as compliance with application and business related constraints, and that these specific goals vary from one implementation to another and from one developer to another. Moreover, it is appreciated that such a development effort can be complex and time-consuming, but is nevertheless a routine undertaking of engineering for those of ordinary skill in the art having the benefit of this disclosure.

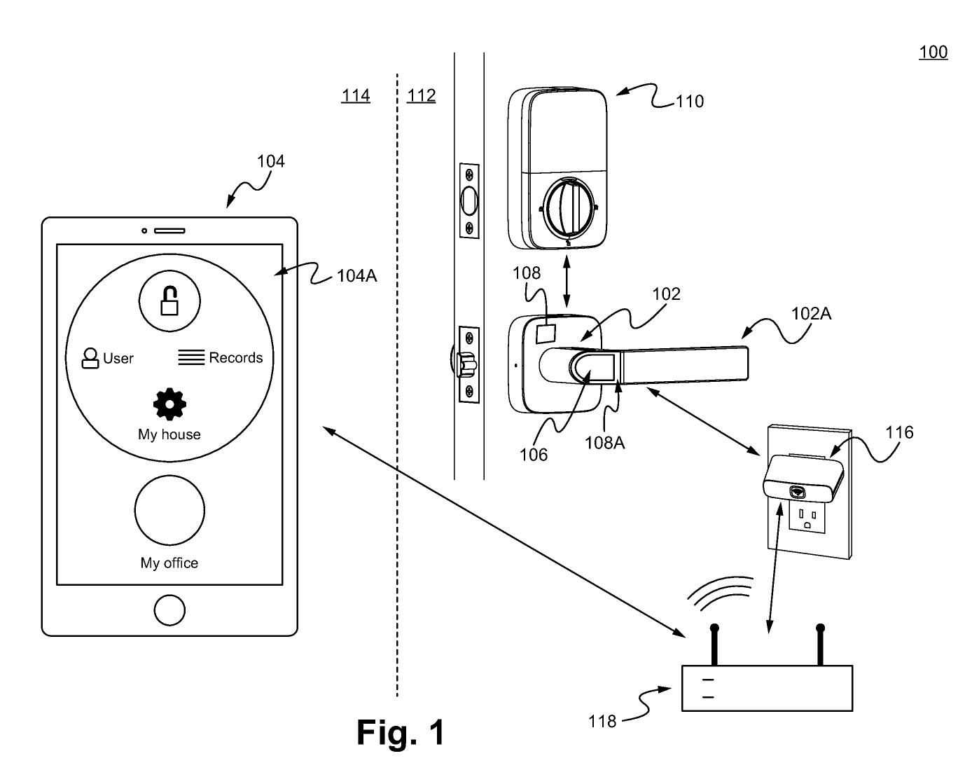

FIG. 1 illustrates a smart lock system 100 in accordance with some embodiments. In some embodiments, the smart lock system 100 comprises a lock 102.

In some embodiments, the lock 102 comprises a handle 102A and an identity verification device 106. In some embodiments, the identity verification device 106 comprises a fingerprint scanning and verification device. In some embodiments, the identity verification device 106 is located around/at the rotational pivot point of the handle 102A, such that a user is able to have his/her identity verified concurrently when holding the handle. It is one of the advantageous features, such that the user is able to have identification verified and have the door unlocked in one motion (e.g., handle holding motion). With the feature described above, the user does not need to have the identification verified first, move to hold the handle, and turn the handle separately. A person of ordinary skill in the art appreciates that the identity verification device 106 is able to be structured to be at any location on the lock 102. For example, on a round door knob, the identity verification device 106 is able to be at the center of the door knob.

In some embodiments, an application (APP) 104A installed on a smart phone or any mobile device 104 is used to remotely lock/unlock the lock 102. The APP 104A comprises software installed on a smart phone 104. The APP 104A is constructed to change the physical positions of the lock. For example, a user is able to click a selectable icon on the APP installed on the smart phone 104, which instructs the lock 102 to change its physical status, such as from open to lock or from lock to open. In an exemplary example, when the lock 102 receives the instruction to open the lock 102, the lock 102 is able to engage corresponding gears and components to move in a predetermined manner, such as having the gears make 5 circles of clockwise turn. The clockwise gear movement causes/drives a locking metal moving inward toward the door, which withdraws its locking body from a protrusion position.

In another embodiment, when the lock 102 receives the instruction to lock/close the lock 102, the lock 102 makes the above mentioned gears rotate 5 counterclockwise circles. Thus, the locking metal (e.g., bolt) is driven from a withdrawn position to a protruded position, which provides a physical structure for engaging the hole on the frame of the door.

In another exemplary embodiment, the lock 102 is already in an opened status while receiving another open instruction from the user's smart phone 104. The lock 102 is able to dismiss the inconsistent order/instruction or make the gears still turn without engaging the locking metal. As described above, the APP 104A comprises computer executable instructions that are able to be executed by the user via a user interface on a smart phone 104, wherein the APP 104A configures the lock 102 to change the configuration of its internal mechanical structures based on the instructions executed by the user.

In some embodiments, the mobile device 104 is able to remotely control the lock 102 via a Wi-Fi-to-bluetooth signal converting bridge (e.g, a bridge connector). For example, the mobile device 102 sends a signal via the Internet to an Internet hub/router 118. The internet router 118 uses a Wi-Fi signal to communicate with a bridge connector 116. The bridge connector 116 uses bluetooth signal to communicate with the lock 102. The bridge connector 116 is configured to be within a bluetooth signal range from the door, such as within 6 feet. The bridge connector 116 sends the control signal via a bluetooth signal to the lock 102 for performing a control motion. The lock 102 sends a control signal to the bolt 110.

In some embodiments, the lock 102 comprises a sensing device 108, such as a near field communication (NFC) receiver and/or a radio-frequency identification chip (RFID). A user is able to use a RFID or NFC enabled card (e.g., keycard) or device to be within a pre-selected signal communicable/transmittable range with the sensing device 108 and/or 108A for an identification verification, which in turn results in a control command for the lock 102. For example, when the lock 102 detects the presence of the keycard within a pre-determined range or exceeds a threshold signal strength, it is determined as an access grant, which is used to unlock the lock 102.

In some embodiments, the locks are in a building structure 112 and the smart phone is located outside 114 of the building structure 112. In some embodiments, the smart phone is located outside 114 of the building structure 112 far enough that Wi-Fi and other typical local internet signals are not reachable directly. In some embodiments, the smart phone 104 is used inside of the building structure 112 for controlling the look 102 via an external Internet signal to talk to the Wi-Fi router 118 inside the building structure 112.

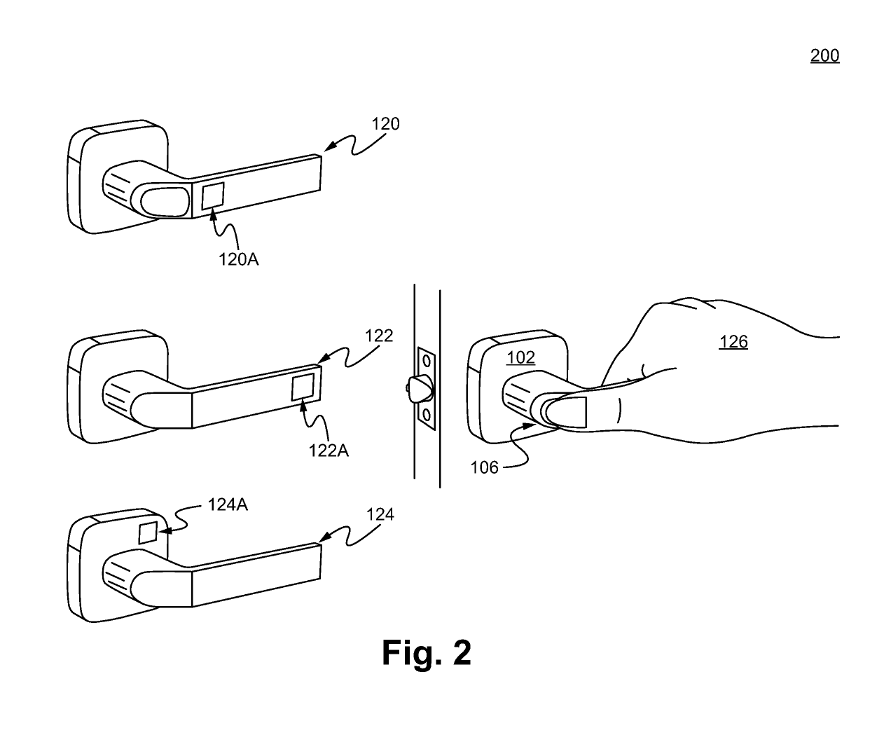

FIG. 2 illustrates various constructions of the identification verification devices on a smart lock system 200 in accordance with some embodiments. As shown in the FIG. 2, the identification verification device 120A is at a proximate end of a handle 120, which is not in or not entirely in the rotating axis of the handle. In some embodiments, the verification device 122A is at a distal end of a handle 122. In some embodiments, the verification device 124A is at a base of a lock 124. A person of ordinary skill in the art appreciates that one or more of the verification device are able to be structured anywhere on or near the body of the lock 102, so long as s typical user is able to reach the verification devices while hold on the handle of the lock 102 or a typical door handle. In an example, a user 126 is holding on the handle of the lock 102 while having his/her finger in physical contact with an identity verification device 106.

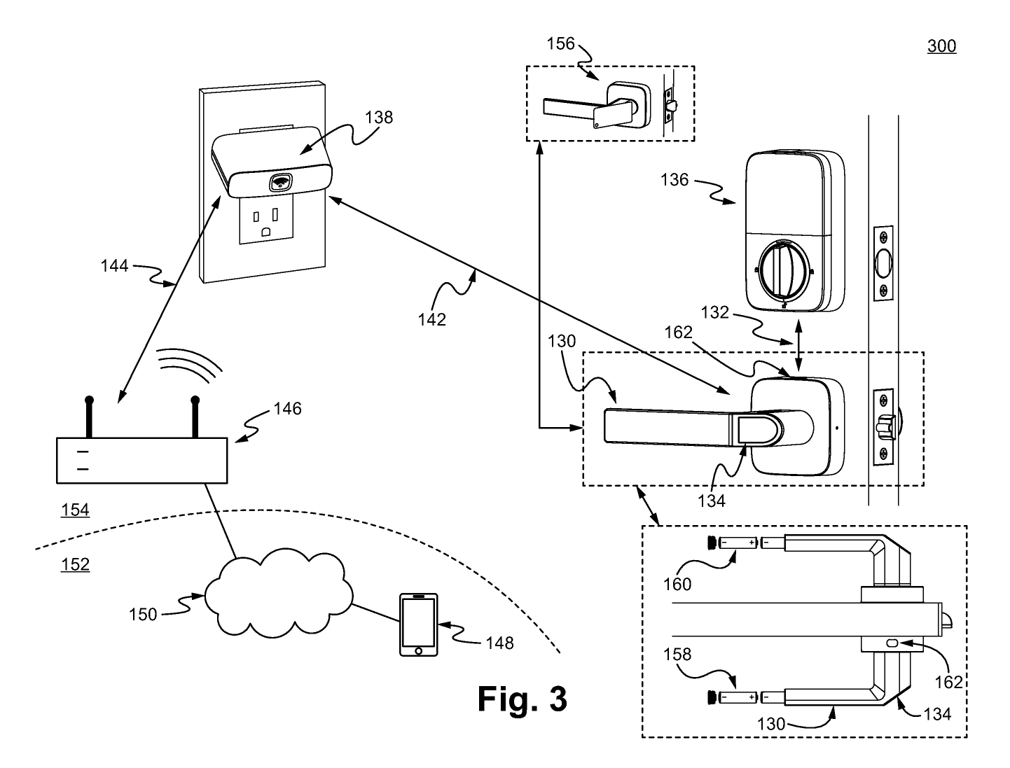

FIG. 3 illustrates an electronic locking system 300 in accordance with some embodiments. In some embodiments, the electronic locking system 300 comprises an electronic locking bolt 136, which is able to be controlled together with the lock 130. In some embodiments, the electronic locking bolt 136 is signally coupled with the lock 130 using IR signal 132 or any other appropriate signals (e.g., bluetooth). A user is able to control the lock 130 and the bolt 136 together remotely using a personal device 148. The smart device 148 transmits Internet signals via cloud 150 to a local Wi-Fi hub 146. The Wi-Fi Hub 146 communicates with the bridge 138 via a Wi-Fi signal 144. In the house, 154, the bridge 138 communicates with the lock 130 via Bluetooth receiver 134 via a bluetooth signal 142. The lock 130 and the bolt 136 are able to be used in indoor configurations and/or outdoor configurations.

In an actual use example, a user is able to get access to open both the lock 130 and the bolt 136 concurrently via one of his/her personal device 148 from outside 152 (e.g., Internet connectivity), radio frequency access card 156 (e.g., a keycard; IR or bluetooth signals), and fingerprint identification device, which provides both a heightened security and convenience to the user.

In some embodiments, each side of the lock, which is on different sides of the door, contains a battery container or power supply. For example, the battery 158 is contained at the inner side of door and the battery 160 is contained at the outside of the door. It is advantageous to have batteries at both sides of the lock. In the event when the battery is out of power at either or both sides, a user is able to just replace batteries of one side to open the door, which avoids locking out due to an out of power situation.

In some embodiments, a three color LED indicator is located at the lock 130, which shows a locking status of an authorized access or denial, which is able to be located at or around the IR transmitter 162. In some embodiments, the IR transmitter 162 is used to communicate with the electronic locking bolt 136.

In some embodiments, lock 130 has a sensing device for sensing the presence of a finger, such as IR sensors, heat sensors, or light sensors. When a finger reaches the fingerprint reading point, the system 200B automatically wakes up/activates the fingerprint verification device.

In some embodiments, lock 130 is configured to perform auto relock, privacy lockout, and free passage, which is configurable by using the APP discussed above or can be setup using predetermined conditions (e.g., after a predetermined duration or time). In some embodiments, the handles are reversible so that the lock can be installed on left or right sides of a door.

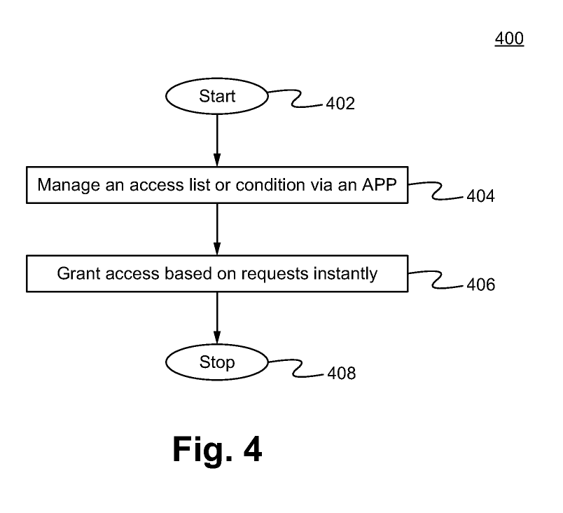

FIG. 4 illustrates a method 400 of using the lock system in accordance with some embodiments. The method starts at a Step 402. At a Step 404, an access list is managed on an APP via the phone or a website. The App is able to communicate with a server, which manages an access log. The access log records/determines the list of persons or conditions that are granted with access or denial. For example, a user is able to pre-set an unlocking status during the business hours from 9 am to 5 pm on the access log, such that the lock becomes unlocked/automatically unlocked at the pre-defined time. The access log also keeps a record who has accessed/entered the door/tried and denied, which can be used as a security record.

At a Step 406, access based requests are also able to be sent to the user/owner for an instant or immediate decision to grant access. In an example, a deliveryman is requesting a temporary opening of the door for dropping of delivery goods. After the deliveryman communicated with the user/owner, the user is able to remotely grant temporary access, such as 5 seconds, to the deliveryman (e.g., buzz in). The method 400 stops at a Step 408.

The locking system (e.g., smart locking system) is able to be installed at vacation home, front door, garage door, offices, storage room, wine cellar, gun lock storage, and/or Airbnb (e.g., for lease control), which offers security and privacy to the property owners or managers. The locking system is also able to be used as office room managements (e.g., for office sharing and conference booking). The locking system is also able to provide the functions of sharing a key for multiple users or access permits as needed, which are able to be managed by the access log managed by one or more computer servers.

To utilize the smart lock, a mobile device is used to remotely control the lock via a phone APP, a smart keycard is used for contactless control, and/or a fingerprint is used for identity identification and/or getting permission.

In operation, the smart lock operates its locking mechanisms and structures after the verification of the identity and/or receiving the control command. In some embodiments, the smart lock is configured to auto-relock after a pre-determined time duration, such as 5 seconds and/or 5 mins.

The present invention has been described in terms of specific embodiments incorporating details to facilitate the understanding of principles of construction and operation of the invention. Such reference herein to specific embodiments and details thereof is not intended to limit the scope of the claims appended hereto. It is readily apparent to one skilled in the art that other various modifications can be made in the embodiment chosen for illustration without departing from the spirit and scope of the invention as defined by the claims. Features in various examples or embodiments are applicable throughout the Present Specification.

What is claimed is:

1. A smart lock comprising:
a) an electronic lock; and
b) a first identity verification component at a pivotal rotating point of a handle on the electronic lock.

2. The smart lock of claim 1, wherein the first identity verification device comprises a fingerprint verification device.

3. The smart lock of claim 1, wherein the pivotal rotating point is positioned at a rotational axis of the handle.

4. The smart lock of claim 1, wherein the electronic lock comprises a second identity verification component operable using a wireless signal.

5. The smart lock of claim 4, wherein the second identity verification component comprises a keycard.

6. The smart lock of claim 5, wherein the keycard comprises radio-frequency circuits.

7. The smart lock of claim 6, wherein the radio-frequency circuits comprise radio-frequency identification (RFID) circuits.

8. The smart lock of claim 4, wherein the second identity verification component comprises a control component configured to receive a control command from a smart phone.

9. The smart lock of claim 4, wherein the lock comprises two sets of batteries located at both sides of the lock, such that the lock is able to be powered from each side of the electronic lock.

10. A method of controlling a locking device comprising:
a) configuring the locking device to receive an identity verification information from a fingerprint verification device, a smart keycard, a smart phone, or a combination thereof;
b) receiving the identify verification information from at least one of the fingerprint verification device, the smart keycard, or the smart phone;
c) determining an access permission using a computing device;
d) generating a granted access permission or a denied access permission based on the access permission determined; and
e) causing the locking device to lock or open based on the generated granted access permission or the denied access permission.

11. The method of claim 10, further comprising configuring a bridge connector to receive a Wi-Fi signal and convert the Wi-Fi signal to a bluetooth signal.

12. The method of claim 11, wherein the bridge connector communicates with the locking device using the bluetooth signal.

13. The method of claim 10, further comprising recording the granted access, the denied access, or both in a log stored in a computing device.

14. The method of claim 13, wherein the log records a name and time of access.

15. The method of claim 10, further comprising opening or locking a separate bolt together with a lock of the locking device.

16. A smart lock system comprising:
a) a fingerprint verification device on a handle of a door lock device;
b) one or more wireless identification verification devices on the door lock device; and
c) at least one set of one or more batteries at each side of the door lock device, so that the door lock device is able to be powered from either side of the door lock device.

17. The device of claim 16, further comprising a bridge connecter, which converts an Internet signal from a user's mobile device in a Wi-Fi signal to bluetooth signal for communicating with the door lock device.
